(19) United States
(12) Patent Application Publication
(10) Pub. No.: US 2020/0242220 A1
(43) Pub. Date: Jul. 30, 2020

(54) AUTHENTICATION USING USER DEVICE MICROPHONE INPUTS

(71) Applicant: EMC IP Holding Company LLC, Hopkinton, MA (US)

(72) Inventors: Leandro Diato, San Francisco, CA (US); Joseph Lacava, Falls Church, VA (US)

(21) Appl. No.: 16/259,391

(22) Filed: Jan. 28, 2019

(51) Int. Cl. G06F 21/31; G06F 3/16

(52) U.S. Cl. CPC G06F 21/31; G06F 3/167

(57) ABSTRACT

Methods, apparatus, and processor-readable storage media for authentication using user device microphone inputs are provided herein. An example computer-implemented method includes generating a prompt via a user device interface; processing, in response to the prompt, input cryptographic information entered via a microphone associated with the user device, wherein the input cryptographic information comprises data pertaining to the microphone and an acoustic pattern generated by one or more fingers and/or one or more accessories; and establishing the input cryptographic information as a set of cryptographic information to be used in connection with an authentication request to access a protected resource associated with the user device.

### FIELD

The field relates generally to information processing systems, and more particularly to techniques for providing security in such systems.

### BACKGROUND

In order to gain access to applications or other resources via a computer or another user device, users are often required to authenticate themselves by entering authentication information. Such authentication information may include, for example, passwords, responses to one or more challenge questions, or other forms of cryptographic or authentication information including voice authentication information. Conventional voice authentication approaches, however, can be cumbersome and not acceptable or plausible in all use case scenarios. For example, vocalizing a password or phrase in the middle of a meeting or while riding on public transportation may not be practical or desirable for a user. Further, background noise in such example settings can increase the failure factor of a voice authentication attempt.

### SUMMARY

Illustrative embodiments of the disclosure provide techniques for authentication using user device microphone inputs. An exemplary computer-implemented method can include generating a prompt via a user device interface, and processing, in response to the prompt, input cryptographic information entered via a microphone associated with the user device, wherein the input cryptographic information includes data pertaining to the microphone and an acoustic pattern generated by one or more fingers and/or one or more accessories. Further, such a method includes establishing the input cryptographic information as a set of cryptographic information to be used in connection with an authentication request to access a protected resource associated with the user device, wherein the authentication request is to be granted if cryptographic information input in response to the authentication request matches the set of cryptographic information.

Additionally, another exemplary computer-implemented method can include establishing a set of cryptographic information, wherein the set of cryptographic information includes data pertaining to at least one microphone and an acoustic pattern generated by one or more fingers and/or one or more accessories in connection with the at least one microphone. Such a method also includes generating a prompt via a user device interface in connection with an authentication request to access a protected resource associated with the user device. Further, such a method includes processing input cryptographic information entered via the user device interface in response to the prompt against the set of cryptographic information, and resolving the authentication request based on the processing.

Illustrative embodiments can provide significant advantages relative to conventional voice authentication techniques. For example, challenges associated with requiring vocal interactions with a microphone in inopportune contexts are overcome through combining an acoustic pattern (based on taps, scratch and pauses) and the acoustic fingerprint captured by the device.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for authenticating using user device microphone inputs in an illustrative embodiment.

FIG. 2 shows another information processing system configured for authenticating using user device microphone inputs in an illustrative embodiment.

FIG. 3 is a system diagram of an exemplary mobile device on which at least one embodiment can be implemented;

FIG. 4 is a system diagram of exemplary mobile device components, in accordance with at least one embodiment;

FIG. 5 shows an example use case involving interacting directly with an on-device microphone, in accordance with an illustrative embodiment.

FIG. 6 shows an example use case involving using a microphone external to a user device, in accordance with an illustrative embodiment.

FIG. 7 shows an example use case involving using an accessory to interact with a microphone, in accordance with an illustrative embodiment.

FIG. 8 shows an example use case involving the use of external accessories to interact with a microphone, in accordance with an illustrative embodiment.

FIG. 9 shows an example use case involving using a wireless microphone external to a user device, in accordance with an illustrative embodiment.

FIG. 10 shows an example use case involving using an accessory to interact with a wireless microphone, in accordance with an illustrative embodiment.

FIG. 11 shows an example use case involving the use of external accessories to interact with a wireless microphone, in accordance with an illustrative embodiment.

FIG. 12 is a flow diagram of an enrollment process for authentication using user device microphone inputs in an illustrative embodiment.

FIG. 13 is a flow diagram of a process for authentication using user device microphone inputs in an illustrative embodiment.

FIGS. 14 and 15 show examples of processing platforms that may be utilized to implement at least a portion of an information processing system in illustrative embodiments.

### DETAILED DESCRIPTION

Illustrative embodiments of the present invention will be described herein with reference to exemplary computer networks and associated computers, servers, network devices or other types of processing devices. It is to be appreciated, however, that the invention is not restricted to use with the particular illustrative network and device configurations shown. Accordingly, the term “computer network” as used herein is intended to be broadly construed, so as to encompass, for example, any system comprising multiple networked processing devices.

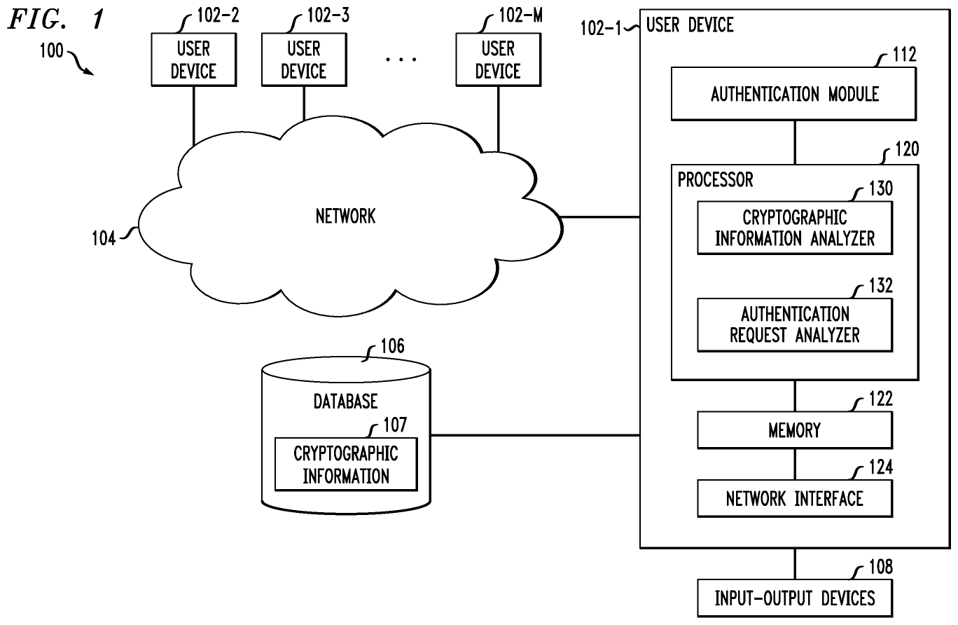

FIG. 1 shows a computer network (also referred to herein as an information processing system) 100 configured in accordance with an illustrative embodiment. The computer network 100 comprises a plurality of user devices 102-1, 102-2, 102-3, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment.

The user devices 102 may comprise, for example, mobile telephones, laptop computers, tablet computers, desktop computers or other types of devices capable of supporting user logins, in any combination. Such devices are examples of what are more generally referred to herein as “processing devices” or “computing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, one or more of the user devices 102 can have an associated database 106 configured to store data 107 pertaining to cryptographic information associated with authentication events, which may comprise, for example, authentication data or other types of login data including acoustic fingerprints and other information associated with login events.

The database 106 in the present embodiment is implemented using one or more storage systems associated with user devices 102. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with one or more of the user devices 102 are input-output devices 108, which illustratively comprise one or more microphones, keyboards, displays or other types of input-output devices in any combination. Such input-output devices can be used, for example, to support one or more user interfaces to user devices 102, as well as to support communication between user devices 102 and other related systems and devices not explicitly shown. Additionally, as further detailed herein, such input-output devices 108 can be resident and/or internal to the user device 102 or can be external devices connected to the user device 102 via a wired or wireless connection.

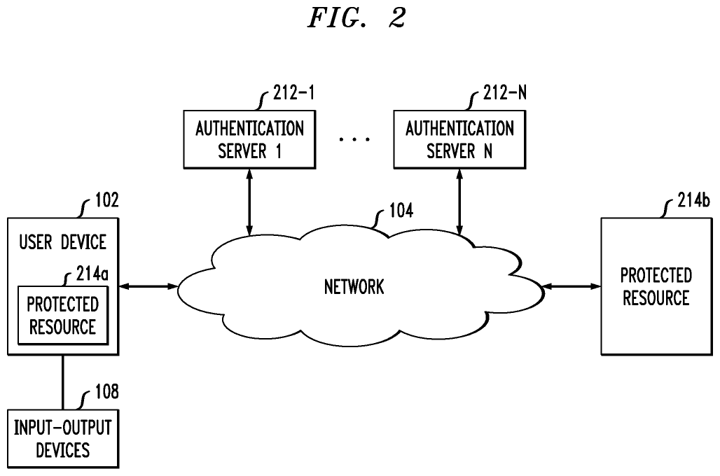

As also depicted in the example embodiment detailed in FIG. 1, user device 102-1 comprises an authentication module 112. The authentication module 112 determines if a given access attempt is authentic based on presentation of one or more predetermined authentication factors such as user identifiers, acoustic fingerprints, passwords or other factors (as further detailed herein). Upon verification of the presented authentication factors, the authentication module 112 grants the requesting user device 102-1 access to one or more protected resources of the computer network 100. Although shown as an element of the user device 102-1 in this embodiment, the authentication module 112 in other embodiments can be implemented at least in part externally to a user device 102, for example, as a stand-alone server, set of servers or other type of authentication system coupled to the network 104 (such as depicted in FIG. 2 via authentication servers 212, for example).

Each user device 102 in the FIG. 1 embodiment is assumed to be implemented using at least one processing device. Each such processing device generally comprises at least one processor and an associated memory, and implements one or more functional modules for controlling certain features of the user device 102.

More particularly, user devices 102 in this embodiment each can comprise a processor 120 coupled to a memory 122 and a network interface 124.

The processor 120 illustratively comprises a microprocessor, a microcontroller, an application-specific integrated circuit (ASIC), a field-programmable gate array (FPGA) or other type of processing circuitry, as well as portions or combinations of such circuitry elements.

The memory 122 illustratively comprises random access memory (RAM), read-only memory (ROM) or other types of memory, in any combination. The memory 122 and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals.

The network interface 124 allows the user devices 102 to communicate over the network 104 with the user devices 102, and illustratively comprises one or more conventional transceivers.

The processor 120 further comprises a cryptographic information analyzer 130 and an authentication request analyzer 132.

It is to be appreciated that this particular arrangement of modules 130 and 132 illustrated in the processor 120 of the FIG. 1 embodiment is presented by way of example only, and alternative arrangements can be used in other embodiments. For example, the functionality associated with the modules 130 and 132 in other embodiments can be combined into a single module, or separated across a larger number of modules. As another example, multiple distinct processors can be used to implement different ones of the modules 130 and 132 or portions thereof.

At least portions of the cryptographic information analyzer 130 and authentication request analyzer 132 may be implemented at least in part in the form of software that is stored in memory 122 and executed by processor 120. Similarly, at least portions of the authentication module 112 of user device 102-1 can be implemented at least in part in the form of software that is stored in memory 122 and executed by processor 120.

It is to be understood that the particular set of elements shown in FIG. 1 for authenticating using user device microphone inputs involving user devices 102 of computer network 100 is presented by way of illustrative example only, and in other embodiments additional or alternative elements may be used. Thus, another embodiment may include additional or alternative systems, devices and other network entities, as well as different arrangements of modules and other components.

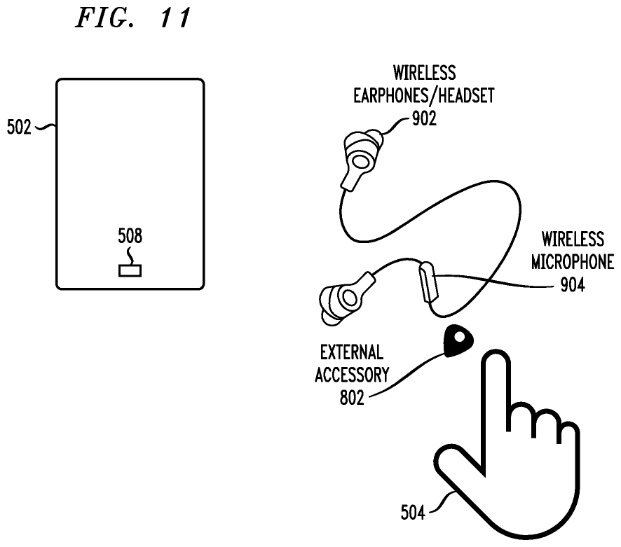

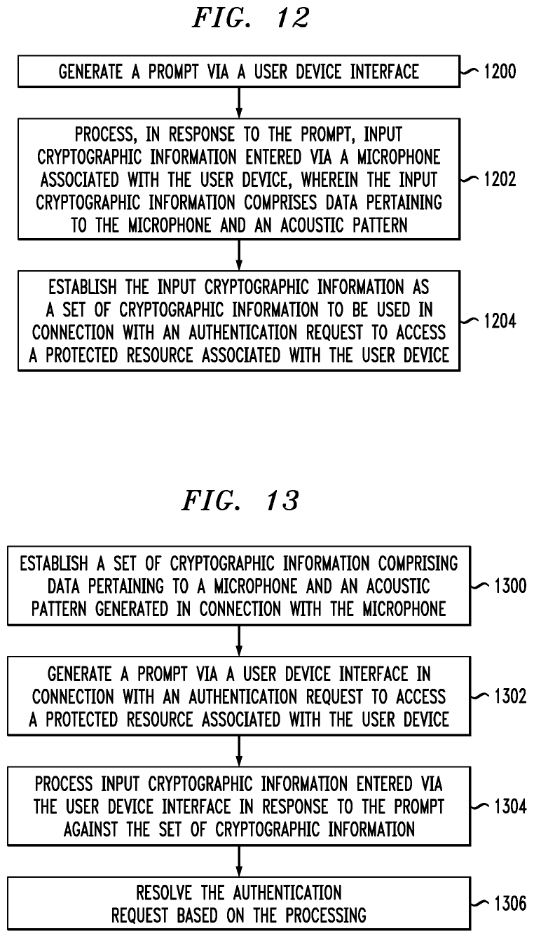

An exemplary process utilizing cryptographic information analyzer 130 and authentication request analyzer 132 of an example user device 102 in computer network 100 will be described in more detail with reference to the flow diagrams of FIG. 12 and FIG. 13.

FIG. 2 is a system diagram of an illustrative embodiment. By way of illustration, FIG. 2 depicts an alternative embodiment to FIG. 1, wherein an authentication server(s) 212 is/are not resident on the user device(s) 102, but rather are separate devices. Accordingly, as depicted in FIG. 2, user device 102 communicates with a protected resource 214a over network 104. As detailed further below, at least one embodiment can also include a user device 102 that includes protected resource 214b residing thereon. In an example implementation, a user authenticates online with one or more authentication servers 212-1 through 212-N (hereinafter, collectively referred to as authentication servers 212) before obtaining access to protected resource 214a, 214b, etc. (hereinafter, collectively referred to as protected resource 214 unless otherwise specified).

According to one aspect of the disclosure, as noted above, the user of the user device 102 is authenticated by authentication servers 212 using an acoustic fingerprint, password, challenge questions, and/or other forms of cryptographic information. The exemplary communications among the system elements 102, 104 and 214 of FIG. 2 to achieve authentication by the authentication servers 212 are discussed further below.

Additionally, similar to the described embodiment of FIG. 1 above, also associated with the user device 102 is one or more input-output devices 108, which illustratively comprise one or more microphones and/or related input-output devices such as detailed herein. Further, such input-output devices 108 can be resident and/or internal to the user device 102 or can be external devices connected to the user device 102 via a wired or wireless connection.

It is to be appreciated that a given embodiment of the disclosed system may include one or more instances of user device 102, input-output devices 108, and protected resource 214, and possibly other system components, although the instances of such components shown in the simplified system diagram of FIG. 2 are presented for clarity of illustration.

As noted herein, user device 102 may represent a portable device, such as a mobile telephone, personal digital assistant (PDA), wireless email device, game console, etc. The user device 102 may alternatively represent a desktop or laptop personal computer (PC), a microcomputer, a workstation, a mainframe computer, a wired telephone, a television set top box, or any other information processing device which can benefit from the use of authentication techniques in accordance with the invention.

The user device 102 may also be referred to herein as simply a “user.” The term “user,” as used in this context, should be understood to encompass, by way of example and without limitation, a user device, a person utilizing or otherwise associated with the device, or a combination of both. An operation described herein as being performed by a user may therefore, for example, be performed by a user device, a person utilizing or otherwise associated with the device, or by a combination of both the person and the device. Similarly, a password, challenge question, or other cryptographic information described as being associated with a user may, for example, be associated with a user device 102, a person utilizing or otherwise associated with the device, or a combination of both the person and the device.

As also depicted in FIG. 2, the authentication servers 212 can be associated with a third-party entity, such as an authentication authority, that processes authentication requests on behalf of web servers and other resources, as well as verifies the cryptographic information that is presented by a user device 102.

Further, the protected resource 214 may be, for example, an access-controlled application, web site or hardware device. In other words, a protected resource 214 is a resource that grants user access responsive to an authentication process, as will be described in greater detail below. For example, protected resource 214a may include an access-controlled file, e-mail, a protected application, a remote application server such as a web site or other software program or hardware device that is accessed by the user device 102 over a network 104.

Additionally, in at least one embodiment, protected resource 214b can include one or more applications or data residing on the user device 102 itself. For example, such a protected resource 214b can include access to a mobile data management container for launching applications on the user device 102 (such as a mobile device), which can be protected by requiring authentication in order to run the application(s) protected by the container. Further, protected resource 214b could also include an access-controlled file, e-mail, a protected application, a remote application server such as a web site or other software program or hardware device that is accessed by the user device 102 over network 104. Similarly, it is possible that in order to unlock the mobile platform to perform operations, a successful authentication might be required.

Accordingly, in one or more embodiments, a protected resource can be present, enrollment information can be present, and an authentication process can occur exclusively on a user device 102 (without a need for a network connection) or over a network connection in conjunction with one or more additional systems or devices.

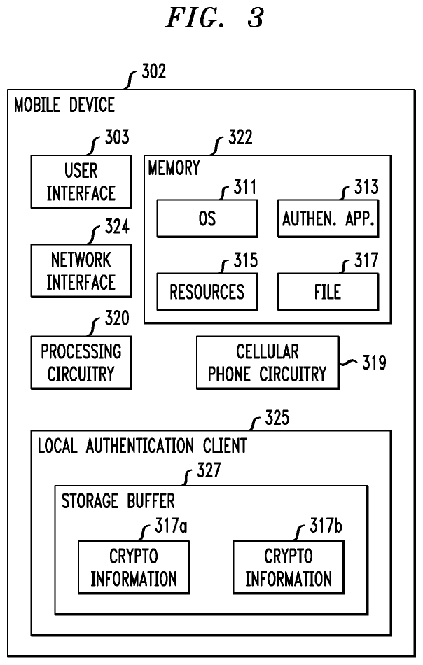

FIG. 3 is a system diagram of an exemplary mobile device 302 (which can represent an example of a user device 102 such as depicted in FIG. 1 and FIG. 2) on which at least one embodiment can be implemented. By way of illustration, FIG. 3 depicts a network interface 324 of the mobile device 302 configured to connect the mobile device 302 to a communications medium such as, for example, Wi-Fi and/or cellular telephony. Accordingly, the network interface 324 enables the mobile device 302 to communicate with the other components of an electronic environment. Additionally, the mobile device 302 includes a user interface 303 configured to receive user input and provide user output, such as a data file and/or data file location selection(s), such as described herein. One or more embodiments can include components such as a display screen, a capacitive touch display, and a push-button keyboard implemented for use in connection with the user interface 303.

Additionally, for completeness, cellular phone circuitry 319 within mobile device 302 allows the user to establish cellular phone calls with other callers having remote devices, as would be appreciated by one skilled in the art.

The memory 322 of mobile device 302 is configured to store one or more software constructs including, for example, an operating system 311, an authentication application 313, data for protected resources 315 (documents, restricted applications, etc.), a cryptographic information file 317, as well as other suitable or relevant material. Further, the processing circuitry 320 of mobile device 302 is configured to operate in accordance with the software constructs stored in the memory 322. By way of example, when the processing circuitry 320 runs the operating system 311, the processing circuitry 320 provides a secure electronic platform on which a user is able to carry out work. Such an electronic platform is capable of operating, for example, as a container to protect data and requiring user authentication before permitting access. Further, when the processing circuitry 320 runs the authentication application 313, the processing circuitry 320 communicates with the local authentication client 325 in a secure manner, for example, to obtain cryptographic information 317(a), 317(b), etc. from storage buffer 327, as additionally described herein.

It should be appreciated that the processing circuitry 320 can include one or more processors running specialized software components, such as detailed in connection with the techniques detailed herein.

In at least one embodiment, once the mobile device 302 is able to obtain valid cryptographic information, the user of the mobile device 302 is able to perform local user authentication to access protected resources. Accordingly, as noted, the mobile device 302 is provisioned with the authentication application 313 and cryptographic information file 317 holding pre-determined and/or established cryptographic information. For example, and as further detailed herein, such pre-determined cryptographic information can include an acoustic pattern that includes one or more sounds generated by touching a microphone and one or more periods of time lacking a sound generated by touching a microphone. As further described herein, such cryptographic information can be learned and updated over time.

Consequently, the processing circuitry 320 of the mobile device 302 can perform a local cryptographic operation using cryptographic information 317 stored in the memory 322. In at least one embodiment, the processing circuitry 320 runs the authentication application 313, which directs the user of the mobile device 302, via the user interface 303, to enter cryptographic information which is captured as one or more acoustic patterns 317(a). Additionally, the processing circuitry 320, via a software component resident thereon, can process input and output information, such as, for example, associated with an enrollment process of microphone data/metadata 317(b) related to the one or more acoustic patterns 317(a). While the captured cryptographic information 317(a) and 317(b) is temporarily stored in the storage buffer 327 of the local authentication client 325, the authentication application 313 compares the captured user-provided cryptographic information 317(a) and 317(b) with the appropriate expected items of cryptographic information from file 317.

If a match is determined via this comparison, the authentication application 313 permits the user to access a protected resource (such as, for example, data in association with element 315 that are stored in the memory 322).

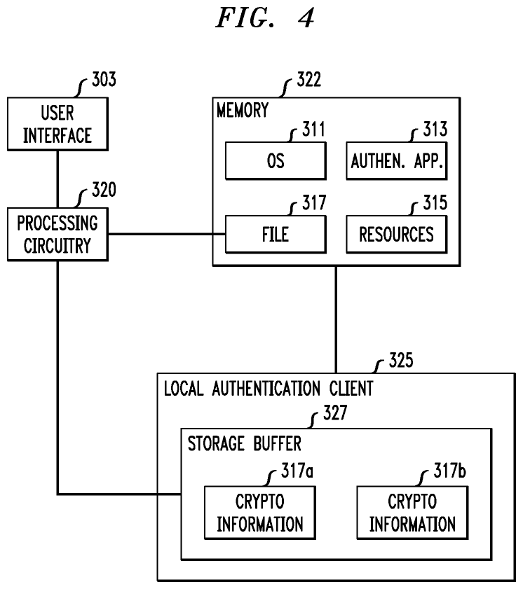

FIG. 4 is a system diagram of exemplary mobile device components, in accordance with at least one embodiment. As depicted in FIG. 4, a user can enter cryptographic information via user interface 303 (which can be implemented in conjunction with, for example, a microphone resident on the device 302 or externally connected to the device 302). This entered cryptographic information is captured as one or more acoustic patterns 317(a) and microphone data/metadata 317(b) related thereto.

Accordingly, the captured cryptographic information 317(a) and 317(b) can be stored in cryptographic information file 317 as the pre-determined and/or established cryptographic information for a given (subsequent) cryptographic process.

Consequently, a corresponding cryptographic flow (carried out, for example, by authentication application 313 as run by operating system 311) can take the following exemplary form. The user is prompted (via user interface 303) to enter cryptographic information in connection with an authentication request to access a protected resource associated with the mobile device (for example, the user wishes to access and/or unlock his or her smart phone). The entered cryptographic information is captured by the processing circuitry 320 as one or more acoustic patterns 317(a) and microphone data/metadata 317(b) corresponding to the one or more acoustic patterns 317(a), and stores both 317(a) and 317(b) temporarily in the storage buffer 327 of the local authentication client 325.

Subsequently, the authentication application 313 compares the captured cryptographic information 317(a) and 317(b) with the pre-determined cryptographic information from file 317 stored in memory 322. If the captured cryptographic information 317(a) and 317(b) match those stored in file 317 (in the sequence and/or manner proscribed by the data stored in file 317), authentication is deemed successful and the user is granted access to the protected resource in question.

Accordingly, at least one embodiment includes linking authentication to a specific microphone and an acoustic pattern of interaction involving the microphone, optionally combined with one or more particular elements used in the interaction with the microphone. As detailed herein, such an element used to interact with the microphone can include, for example, a fingernail, a ring (worn on a user's finger), an accessory attached to a headphone cord, etc. As such, one or more embodiments includes leveraging a usability aspect of generating sounds directly into an integrated device microphone or an external microphone (as part of a headset, for example) as at least a portion of an authentication method.

As used herein, an acoustic “pattern” includes a combination of any number of taps, scratches and/or pauses, in any order. Additionally, a tap is the sound generated by touching the microphone for a minimum allowed time (also referred to herein as the minimum tap-time) sufficient to be generated and recorded, while not exceeding the tap maximum threshold time (also referred to herein as the maximum tap-time). In one or more embodiments, a tap ends when a pause is detected. Similarly, a scratch is the sound generated and recorded by the microphone that surpasses the maximum tap-time until a pause is detected. Also, a pause is the absence of any direct sound captured by the microphone. As also used herein, frequency refers to the number of occurrences of a repeating event per unit of time, and a sample refers to a waveform over time.

As further detailed herein, one or more embodiments include an enrollment process and an authentication process. During enrollment, a user will define the acoustic/sound pattern to be used as the established cryptographic information (for subsequent authentication processes). In at least one embodiment, a minimum number of taps, scratches and/or pauses is required (in the acoustic pattern) in order to guarantee a minimum level of entropy. Additionally, in one or more embodiments, the enrollment process can be carried out over a fixed period of time or over a variable amount of time.

Each tap and scratch is analyzed and fingerprinted based on frequency and sample length. From such action, at least one embodiment extrapolates the pitch of the sound being generated and determines the medium generating the waveform. One or more embodiments can require and/or utilize multiple samples, which can further improve reliability of the pattern. The composition of all of the fingerprint values on the pattern are assigned to the pattern for subsequent use during verification/authentication. Additionally, the fingerprint values can be stored on the same device of the enrollment or can be sent and stored at a remote location/database.

In order to perform authentication, the user needs to reproduce the same pattern used during enrollment, within a predetermined acceptance threshold. The sound (input as part of the authentication process) is decomposed and analyzed using the same techniques noted above for enrollment. The resulting acoustic fingerprints are compared with the enrollment values.

Multiple comparison techniques can be used to match enrollment and verification/authentication samples. For example, pauses can be compared based on pause length and a pause-threshold. Also, each of the acoustic fingerprint values (having individual threshold values for taps and scratches) can be individually compared against each other. Additionally, a full pattern acoustic fingerprint value can be generated based on the combination of individual acoustic fingerprint values, and this value can be compared to the stored enrollment value(s). Also, at least one embodiment can include a combination of two or more of the above techniques.

The entropy of this authentication technique depends on one or more factors, including, for example, the number of elements in the pattern, the duration of each scratch, the duration of each pause, the element/material used to tap or scratch the microphone (for instance, using a ring will generate a different acoustic fingerprint than using a finger or a fingernail), and the uniqueness of the element used to tap or scratch the microphone (for instance, using low threshold values and elements (such as a ring) to interact with the microphone adds additional complexity for false-positives).

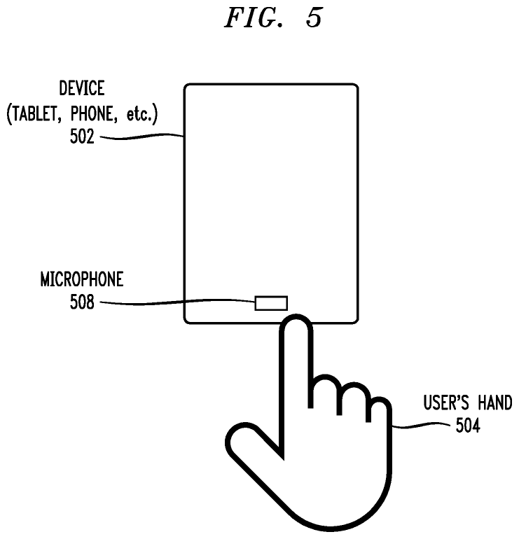

Example use cases involving implementation of embodiments of the disclosure are illustrated in FIG. 5 through FIG. 11 and described below.

FIG. 5 shows an example use case involving a user's hand 504 interacting directly with an on-device microphone 508, in accordance with an illustrative embodiment. In this scenario, the user is directly producing and/or reproducing the acoustic pattern on the device 502 using the device's internal microphone 508 via a finger or nail (of the user's hand 504).

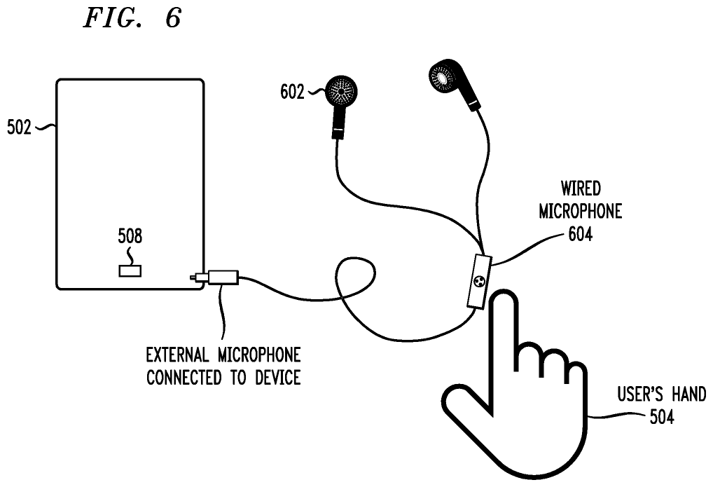

FIG. 6 shows an example use case involving using a microphone 604 external to the user device 502, in accordance with an illustrative embodiment. In such an embodiment, the device 502 has an external accessory 602 (such as a headset or earbuds) connected thereto via a wired connection, wherein the external accessory includes a microphone 604. The acoustic pattern is produced and/or reproduced using the external microphone 604 via a finger or nail (of the user's hand 504).

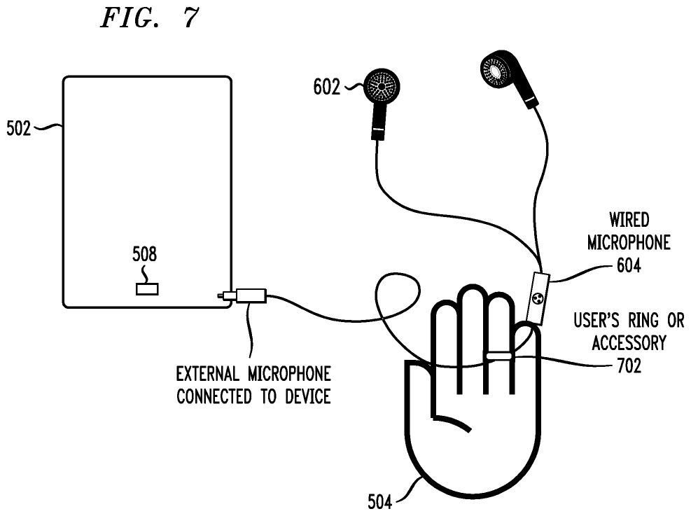

FIG. 7 shows an example use case involving using an accessory 702 to interact with a microphone 604, in accordance with an illustrative embodiment. In such an embodiment, the user is utilizing a ring 702 (or other accessory) to produce and/or reproduce the acoustic pattern using the external microphone 604. Additionally, the ring 702 can be used exclusively or in conjunction with the user's hand 504 to produce and/or reproduce the acoustic pattern.

FIG. 8 shows an example use case involving the use of an external accessory 802 to interact with a microphone 604, in accordance with an illustrative embodiment. An extension of the FIG. 7 use case includes utilizing external accessories 802 to produce and/or reproduce the acoustic pattern using microphone 604. Such external accessories 802 (for example, a guitar pick, a keychain, etc.) can be attached to the external device 602 (such as a headphone cable), attached directly to the user device 502, or unattached from both the external device 602 and the user device 502. Such accessories 802 will assist in generating a unique acoustic fingerprint.

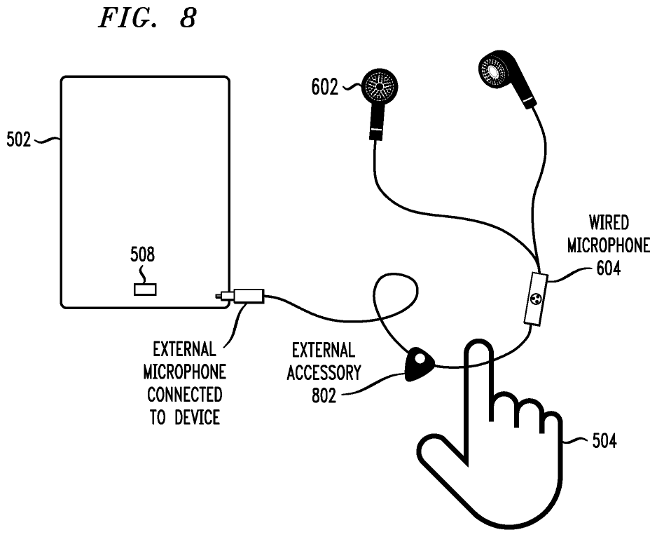

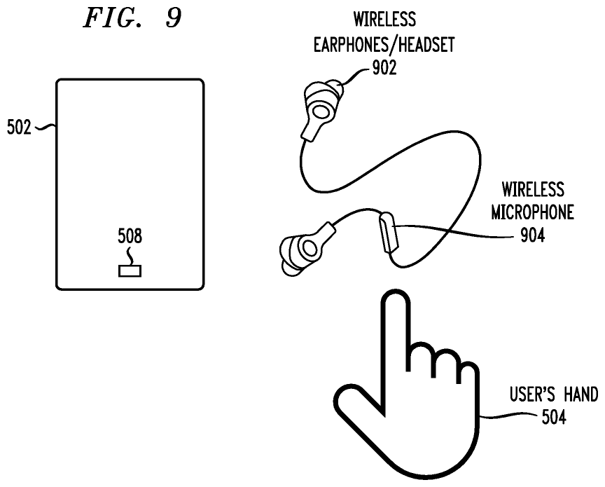

FIG. 9 shows an example use case involving using a wireless microphone 904 external to user device 502, in accordance with an illustrative embodiment. In such an embodiment, the user device 502 has an external accessory 902 (such as a headset or earbuds) connected thereto via a wireless connection, wherein the external accessory includes a microphone 904. The acoustic pattern is produced and/or reproduced using the external microphone 904 via a finger or nail (of the user's hand 504).

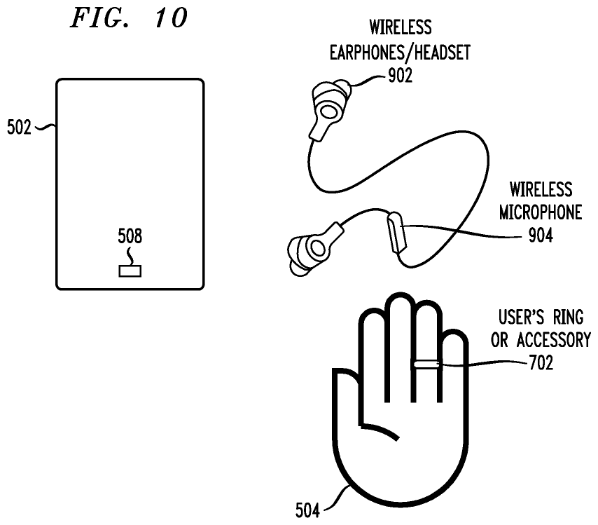

FIG. 10 shows an example use case involving using an accessory 702 to interact with a wireless microphone 904, in accordance with an illustrative embodiment. In such an embodiment, the user is utilizing a ring 702 (or other accessory) to produce and/or reproduce the acoustic pattern using the external (wireless) microphone 904. Additionally, the ring 702 can be used exclusively or in conjunction with the user's hand 504 to produce and/or reproduce the acoustic pattern.

FIG. 11 shows an example use case involving the use of an external accessory 802 to interact with a wireless microphone 904, in accordance with an illustrative embodiment. Such an embodiment includes utilizing one or more external accessories 802 to produce and/or reproduce the acoustic pattern using (wireless) external microphone 904. Such external accessories 802 (for example, a guitar pick, a keychain, etc.) can be attached to the external device 902 (such as a headphone cable), attached directly to the user device 502, or unattached from both the external device 902 and the user device 502. As detailed herein, such accessories 802 will assist in generating a unique acoustic fingerprint.

FIG. 12 is a flow diagram of a process for authentication using user device microphone inputs in an illustrative embodiment. It is to be understood that this particular process is only an example, and additional or alternative processes can be carried out in other embodiments.

In this embodiment, the process includes steps 1200 through 1204. These steps are assumed to be performed by the processor 120 utilizing its modules 130 and 132.

Step 1200 includes generating a prompt via a user device interface.

Step 1202 includes processing, in response to the prompt, input cryptographic information entered via at least one microphone associated with the user device, wherein the input cryptographic information comprises data pertaining to the at least one microphone and an acoustic pattern generated by at least one of one or more fingers and one or more accessories. In at least one embodiment, the input cryptographic information further includes data pertaining to magnitude of the one or more sounds generated by touching the at least one microphone.

The acoustic pattern can include one or more sounds generated by touching the at least one microphone and one or more periods of time lacking a sound generated by touching the at least one microphone. The sounds generated by touching the at least one microphone can include at least a predetermined minimum number of sounds, including, for example, a tap, wherein a tap comprises a sound generated by touching the at least one microphone for more than a predetermined first amount of time and less than a predetermined second amount of time. Additionally, the sounds generated by touching the at least one microphone can include a scratch, wherein a scratch comprises a sound generated by touching the at least one microphone for more than the predetermined second amount of time.

Further, the acoustic pattern can include a sequential combination of one or more sounds generated by touching the at least one microphone and one or more periods of time lacking a sound generated by touching the at least one microphone. Also, the at least one microphone can include one or more of a microphone resident on the user device and an external microphone connected to the user device.

Step 1204 includes establishing the input cryptographic information as a set of cryptographic information to be used in connection with an authentication request to access one or more protected resources associated with the user device, wherein the authentication request is to be granted if cryptographic information input in response to the authentication request matches the set of cryptographic information. Establishing the input cryptographic information as the set of cryptographic information can include analyzing each of the one or more sounds generated by touching the at least one microphone based at least in part on frequency and waveform length. Also, in such an embodiment, establishing the input cryptographic information as the set of cryptographic information further includes extrapolating, based at least in part on the analyzing, a pitch value for each of the one or more sounds, and determining, based at least in part on the pitch values, a medium generating each of the one or more sounds.

Additionally, establishing the input cryptographic information as the set of cryptographic information can include implementing one or more thresholding techniques.

FIG. 13 is a flow diagram of a process for authentication using user device microphone inputs in an illustrative embodiment. It is to be understood that this particular process is only an example, and additional or alternative processes can be carried out in other embodiments.

In this embodiment, the process includes steps 1300 through 1306. These steps are assumed to be performed by the processor 120 utilizing its modules 130 and 132.

Step 1300 includes establishing a set of cryptographic information, wherein the set of cryptographic information comprises data pertaining to at least one microphone and an acoustic pattern generated by at least one of one or more fingers and one or more accessories in connection with the at least one microphone.

Step 1302 includes generating a prompt via a user device interface in connection with an authentication request to access one or more protected resources associated with the user device. Step 1304 includes processing input cryptographic information entered via the user device interface in response to the prompt against the set of cryptographic information. Step 1306 includes resolving the authentication request based on said processing.

In one or more embodiments, the acoustic pattern includes one or more sounds generated by touching the at least one microphone and one or more periods of time lacking a sound generated by touching the at least one microphone. In such an embodiment, processing the input cryptographic information against the set of cryptographic information includes generating an acoustic fingerprint value for each of one or more sounds contained within the input cryptographic information, and individually comparing each generated acoustic fingerprint value to one or more acoustic fingerprint values attributed to the one or more sounds of the acoustic pattern.

Also, in one or more embodiments, the acoustic pattern includes one or more sounds generated by touching the at least one microphone and one or more periods of time lacking a sound generated by touching the at least one microphone. In such an embodiment, processing the input cryptographic information against the set of cryptographic information includes generating an acoustic fingerprint value that represents the combination of one or more sounds contained within the input cryptographic information, and comparing the generated acoustic fingerprint value to an acoustic fingerprint value attributed to the combination of the one or more sounds of the acoustic pattern.

Accordingly, the particular processing operations and other functionality described in conjunction with the flow diagrams of FIG. 12 and FIG. 13 are presented by way of illustrative example only, and should not be construed as limiting the scope of the invention in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to utilize a microphone associated with a user device as an input mechanism for authentication. These and other embodiments can effectively introduce a high level of entropy without the inconvenience of traditional sound-verification methods (such as voice verification, for example) by combining an acoustic pattern and the acoustic fingerprint captured by the device.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems such as Amazon Web Services (AWS), Google Cloud Platform (GCP) and Microsoft Azure. Virtual machines provided in such systems can be used to implement at least portions of one or more of a computer system and a content addressable storage system in illustrative embodiments. These and other cloud-based systems in illustrative embodiments can include object stores such as Amazon S3, GCP Cloud Storage, and Microsoft Azure Blob Storage.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

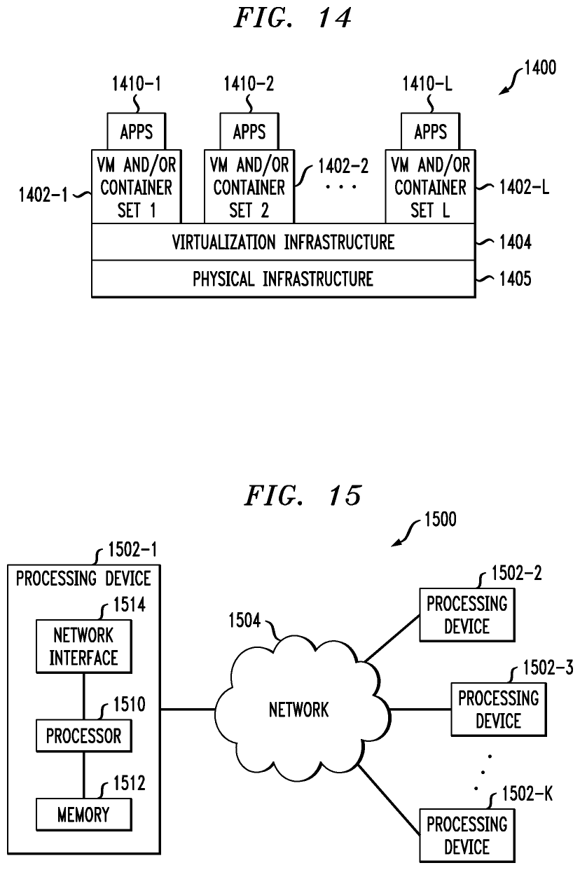

Illustrative embodiments of processing platforms will now be described in greater detail with reference to FIGS. 14 and 15. Although described in the context of system 100, these platforms may also be used to implement at least portions of other information processing systems in other embodiments.

FIG. 14 shows an example processing platform comprising cloud infrastructure 1400. The cloud infrastructure 1400 comprises a combination of physical and virtual processing resources that may be utilized to implement at least a portion of the information processing system 100. The cloud infrastructure 1400 comprises multiple virtual machines (VMs) and/or container sets 1402-1, 1402-2, . . . 1402-L implemented using virtualization infrastructure 1404. The virtualization infrastructure 1404 runs on physical infrastructure 1405, and illustratively comprises one or more hypervisors and/or operating system level virtualization infrastructure. The operating system level virtualization infrastructure illustratively comprises kernel control groups of a Linux operating system or other type of operating system.

The cloud infrastructure 1400 further comprises sets of applications 1410-1, 1410-2, . . . 1410-L running on respective ones of the VMs/container sets 1402-1, 1402-2, . . . 1402-L under the control of the virtualization infrastructure 1404. The VMs/container sets 1402 may comprise respective VMs, respective sets of one or more containers, or respective sets of one or more containers running in VMs. In some implementations of the FIG. 14 embodiment, the VMs/container sets 1402 comprise respective VMs implemented using virtualization infrastructure 1404 that comprises at least one hypervisor.

An example of a hypervisor platform that may be used to implement a hypervisor within the virtualization infrastructure 1404 is the VMware® vSphere® which may have an associated virtual infrastructure management system such as the VMware® vCenter™. The underlying physical machines may comprise one or more distributed processing platforms that include one or more storage systems.

In other implementations of the FIG. 14 embodiment, the VMs/container sets 1402 comprise respective containers implemented using virtualization infrastructure 1404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1400 shown in FIG. 14 may represent at least a portion of one processing platform. Another example of such a processing platform is processing platform 1500 shown in FIG. 15.

The processing platform 1500 in this embodiment comprises a portion of system 100 and includes a plurality of processing devices, denoted 1502-1, 1502-2, 1502-3, . . . 1502-K, which communicate with one another over a network 1504.

The network 1504 may comprise any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1502-1 in the processing platform 1500 comprises a processor 1510 coupled to a memory 1512.

The processor 1510 may comprise a microprocessor, a microcontroller, an application-specific integrated circuit (ASIC), a field-programmable gate array (FPGA) or other type of processing circuitry, as well as portions or combinations of such circuitry elements.

The memory 1512 may comprise random access memory (RAM), read-only memory (ROM) or other types of memory, in any combination. The memory 1512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1502-1 is network interface circuitry 1514, which is used to interface the processing device with the network 1504 and other system components, and may comprise conventional transceivers.

The other processing devices 1502 of the processing platform 1500 are assumed to be configured in a manner similar to that shown for processing device 1502-1 in the figure.

Again, the particular processing platform 1500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from VCE, the Virtual Computing Environment Company, now the Converged Platform and Solutions Division of Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include VNX® and Symmetrix VMAX® storage arrays, software-defined storage products such as ScaleIO™ and ViPR®, all-flash and hybrid flash storage arrays such as Unity™, cloud storage products such as Elastic Cloud Storage (ECS), object-based storage products such as Atmos®, scale-out all-flash storage arrays such as XtremIO™, and scale-out NAS clusters comprising Isilon® platform nodes and associated accelerators, all from Dell EMC. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. For example, the disclosed techniques are applicable to a wide variety of other types of information processing systems in which it is desirable to provide secure authentication processes involving multiple user devices. Also, the particular configurations of system and device elements and associated processing operations illustratively shown in the drawings can be varied in other embodiments. Thus, for example, the particular types of processing platforms, modules, cloud-based systems and virtual resources deployed in a given embodiment and their respective configurations may be varied. Moreover, the various assumptions made above in the course of describing the illustrative embodiments should also be viewed as exemplary rather than as requirements or limitations of the invention. Numerous other alternative embodiments within the scope of the appended claims will be readily apparent to those skilled in the art.

What is claimed is:

1. A computer-implemented method comprising:
generating a prompt via a user device interface;
processing, in response to the prompt, input cryptographic information entered via at least one microphone associated with the user device, wherein the input cryptographic information comprises data pertaining to the at least one microphone and an acoustic pattern generated by at least one of one or more fingers and one or more accessories; and
establishing the input cryptographic information as a set of cryptographic information to be used in connection with an authentication request to access one or more protected resources associated with the user device, wherein the authentication request is to be granted if cryptographic information input in response to the authentication request matches the set of cryptographic information;
wherein the method is performed by at least one processing device comprising a processor coupled to a memory.

2. The computer-implemented method of claim 1, wherein the acoustic pattern comprises one or more sounds generated by touching the at least one microphone and one or more periods of time lacking a sound generated by touching the at least one microphone.

3. The computer-implemented method of claim 2, wherein the one or more sounds generated by touching the at least one microphone comprises at least a predetermined minimum number of sounds.

4. The computer-implemented method of claim 2, wherein the one or more sounds generated by touching the at least one microphone comprises a tap, wherein a tap comprises a sound generated by touching the at least one microphone for more than a predetermined first amount of time and less than a predetermined second amount of time.

5. The computer-implemented method of claim 4, wherein the one or more sounds generated by touching the at least one microphone comprises a scratch, wherein a scratch comprises a sound generated by touching the at least one microphone for more than the predetermined second amount of time.

6. The computer-implemented method of claim 2, wherein the input cryptographic information further comprises data pertaining to magnitude of the one or more sounds generated by touching the at least one microphone.

7. The computer-implemented method of claim 2, wherein establishing the input cryptographic information as the set of cryptographic information comprises analyzing each of the one or more sounds generated by touching the at least one microphone based at least in part on frequency and waveform length.

8. The computer-implemented method of claim 7, wherein establishing the input cryptographic information as the set of cryptographic information further comprises extrapolating, based at least in part on the analyzing, a pitch value for each of the one or more sounds.

9. The computer-implemented method of claim 8, wherein establishing the input cryptographic information as the set of cryptographic information further comprises determining, based at least in part on the pitch values, a medium generating each of the one or more sounds.

10. The computer-implemented method of claim 1, wherein establishing the input cryptographic information as the set of cryptographic information comprises implementing one or more thresholding techniques.

11. The computer-implemented method of claim 1, wherein the acoustic pattern comprises a sequential combination of one or more sounds generated by touching the at least one microphone and one or more periods of time lacking a sound generated by touching the at least one microphone.

12. The computer-implemented method of claim 1, wherein the at least one microphone comprises one or more of a microphone resident on the user device and an external microphone connected to the user device.

13. A non-transitory processor-readable storage medium having stored therein program code of one or more software programs, wherein the program code when executed by at least one processing device causes the at least one processing device to carry out the steps of the method of claim 1.

14. An apparatus comprising:
at least one processing device comprising a processor coupled to a memory;
the at least one processing device being configured:
to generate a prompt via a user device interface;
to process, in response to the prompt, input cryptographic information entered via at least one microphone associated with the user device, wherein the input cryptographic information comprises data pertaining to the at least one microphone and an acoustic pattern generated by at least one of one or more fingers and one or more accessories; and
to establish the input cryptographic information as a set of cryptographic information to be used in connection with an authentication request to access one or more protected resources associated with the user device, wherein the authentication request is to be granted if cryptographic information input in response to the authentication request matches the set of cryptographic information.

15. The apparatus of claim 14, wherein the acoustic pattern comprises one or more sounds generated by touching the at least one microphone and one or more periods of time lacking a sound generated by touching the at least one microphone.

16. The apparatus of claim 15, wherein establishing the input cryptographic information as the set of cryptographic information comprises:
analyzing each of the one or more sounds generated by touching the at least one microphone based at least in part on frequency and waveform length;
extrapolating, based at least in part on the analyzing, a pitch value for each of the one or more sounds; and
determining, based at least in part on the pitch values, a medium generating each of the one or more sounds.

17. A computer-implemented method comprising:
establishing a set of cryptographic information, wherein the set of cryptographic information comprises data pertaining to at least one microphone and an acoustic pattern generated by at least one of one or more fingers and one or more accessories in connection with the at least one microphone;
generating a prompt via a user device interface in connection with an authentication request to access one or more protected resources associated with the user device;
processing input cryptographic information entered via the user device interface in response to the prompt against the set of cryptographic information; and
resolving the authentication request based on said processing;
wherein the method is performed by at least one processing device comprising a processor coupled to a memory.

18. The computer-implemented method of claim 17, wherein the acoustic pattern comprises one or more sounds generated by touching the at least one microphone and one or more periods of time lacking a sound generated by touching the at least one microphone; and
wherein processing the input cryptographic information against the set of cryptographic information comprises:
generating an acoustic fingerprint value for each of one or more sounds contained within the input cryptographic information; and
individually comparing each generated acoustic fingerprint value to one or more acoustic fingerprint values attributed to the one or more sounds of the acoustic pattern.

19. The computer-implemented method of claim 17, wherein the acoustic pattern comprises one or more sounds generated by touching the at least one microphone and one or more periods of time lacking a sound generated by touching the at least one microphone; and
wherein processing the input cryptographic information against the set of cryptographic information comprises:
generating an acoustic fingerprint value that represents the combination of one or more sounds contained within the input cryptographic information; and
comparing the generated acoustic fingerprint value to an acoustic fingerprint value attributed to the combination of the one or more sounds of the acoustic pattern.

20. A non-transitory processor-readable storage medium having stored therein program code of one or more software programs, wherein the program code when executed by at least one processing device causes the at least one processing device to carry out the steps of the method of claim 17.
